(19) United States
(12) Patent Application Publication
(10) Pub. No.: US 2007/0229833 A1
(43) Pub. Date: Oct. 4, 2007

(54) High-sensitivity surface detection system and method

(76) Inventors: Allan Rosencwaig, Danville, CA (US); David Willenborg, Pleasanton, CA (US); Li Chen, Fremont, CA (US)

Correspondence Address: DLA PIPER RUDNICK GRAY CARY US, LLP, 2000 UNIVERSITY AVENUE, E. PALO ALTO, CA, 94303-2248, US

(21) Appl. No.: 11/708,802

(22) Filed: Feb. 20, 2007

Related U.S. Application Data
(60) Provisional application No. 60/776,037, filed on Feb. 22, 2006.
(60) Provisional application No. 60/777,796, filed on Feb. 28, 2006.
(60) Provisional application No. 60/795,836, filed on Apr. 27, 2006.
(60) Provisional application No. 60/810,561, filed on Jun. 1, 2006.
(60) Provisional application No. 60/836,786, filed on Aug. 9, 2006.
(60) Provisional application No. 60/850,038, filed on Oct. 6, 2006.
(60) Provisional application No. 60/859,846, filed on Nov. 16, 2006.

(51) Int. Cl. G01N 21/88

(52) U.S. Cl. 356/426; 356/237.2

(57) ABSTRACT

An inspection system and method for inspecting a sample surface, with a light source for generating a probe beam of light, a high NA lens for focusing the probe beam onto a sample surface, and collecting a scattered probe beam from the sample surface, optics for imaging the scattered probe beam onto a detector having a plurality of detector elements that generate output signals in response to the scattered probe beam, and a processor for analyzing the output signals to identify defects on the sample surface. Shaping the beam into a stripe shape increases intensity without sacrificing throughput. Offsetting the beam from the center of the high NA lens provides higher angle illumination. Crossed polarizers also improve signal quality. A homodyne or heterodyne reference beam (possibly using a frequency altering optical element) can be used to create an interferometric signal at the detector for improved signal to noise ratios.

This application claims the benefit of the following U.S. Provisional Applications: 60/776,037, filed Feb. 22, 2006; 60/777,796, filed Feb. 28, 2006; 60/795,836, filed Apr. 27, 2006; 60/810,561, Filed Jun. 1, 2006; 60/836,786, filed Aug. 9, 2006; 60/850,038, filed Oct. 6, 2006; and 60/859,846, filed Nov. 16, 2006; all of which are incorporated herein by reference in their entirety.

### FIELD OF THE INVENTION

The present invention relates to nondestructive inspection of surfaces, and in particular to the optical inspection of semiconductor wafers for defects.

### BACKGROUND OF THE INVENTION

Optical inspection of semiconductor wafers is a critical requirement for process development, manufacturing ramp-up, yield improvement and ongoing quality control. While the focus of this disclosure concerns semiconductor wafer inspection, the innovations herein can also be applied to other areas as well, such as flat-panel and memory media inspection.

In semiconductor manufacturing, optical inspection is often performed on bare wafers, where the primary defects of interest are particles, pits and scratches. Particles constitute unwanted contamination. Pits in bare silicon wafers are crystal-originated particles (COPS) that are octahedral voids in Czochralski-grown silicon that have been exposed on the surface by the polishing process. In addition, planarized or essentially unpatterned wafers with blanket layers or films are often inspected for micro-sized defects (particles, pits, scratches) after certain process steps, such as deposition and planarization. Also detected in optical inspection is haze, which is primarily scattering from surface micro-roughness.

At present, semiconductor manufacturers are working at the 60 nm technology node where the average transistor line width is 60 nm. Leading-edge manufacturers are beginning to ramp up the 45 nm technology node and plan to ramp up the 32 nm technology node in the next 2 to 3 years. Thus current IC technologies require the detection of micro defects in the 60-45 nm range and will require the detection of micro defects in the 30 nm range within the next several years. In addition, the detection technologies ideally are capable of detecting at least 95% of the defects (a defect capture rate of 95%) with less than 1 part per million (1 ppm) of false counts. Furthermore, to make such an inspection economically viable, the throughput of the inspection system ideally is at least 60 wafers per hour (60 wph). The detection of such small defects on a 300 mm wafer by optical means at such high throughputs and accuracies is a major challenge.

A common way for performing micro-defect inspection on unpatterned wafers is to use a focused probe beam, typically a laser beam, incident at an oblique angle, and to detect the light that is scattered from a micro defect with a dark field configuration (polar scatter angle different from specular direction) or double-dark field configuration (both polar and azimuthal scatter angles different from specular direction). The scattered light is collected by one or more collectors that then direct the light to fast photomultiplier tubes (PMT's).

FIG. 1 illustrates a prior art inspection system using off axis-illumination and an elliptical reflective scattered light collector. The illumination source 10 (typically a laser) provides an illumination beam 12 incident at an oblique angle onto wafer 14. Scattered light 16 from the illuminating area is collected by a large elliptical reflective lens 18, whose axis of rotation is parallel to the normal to the wafer surface. One foci of the ellipse is at the illuminated area, and the other foci is at detector 20. An elliptical collector enables scattered light from a large solid angle to be collected and focused onto detector 20.

FIG. 2 illustrates a prior art inspection system with on-axis illumination separate from the scatter collecting optics. The source 10 provides an illumination beam 12, which passes through lens assembly 26 that ultimately focuses the beam at the wafer surface. The beam then passes through an aperture 19, and is directed normal to the wafer by turning mirror 24. Scattered light 16 from the illuminated area is collected by a large elliptical reflective collector 18. The scattered light collected by elliptical reflective collector 18 is directed to detector 20. The size of the turning mirror 24 must be small compared to the exit aperture of lens 18 to minimize the blocking of the returning scattered light. As the turning mirror size is reduced, the numerical aperture (NA) of the illuminating lens 26 for focusing the illumination beam must also be reduced. Smaller illuminating NA's result in larger illuminating areas, and thus lower power densities.

FIG. 3 illustrates a prior art inspection system with on-axis illumination through the same lens that collects the scattered light. The source 10 provides an illumination beam 12 directed normal to the collecting lens 22 by turning mirror 24. The collecting lens 22 focuses the beam at the wafer surface and illuminates an area of the wafer. Scattered light 16 from the illuminated area is collected by lens 22. The scattered light collected by lens 22 is directed to detector 20. Again, the size of the turning mirror 24 must be small compared to the entrance aperture of lens 22 to minimize the blocking of the returning scattered light. As the turning mirror size is reduced, the effective NA of the collecting lens 22 for focusing the illumination beam is also reduced. As stated above, smaller illuminating lens NA's result in larger illuminating areas, and lower power densities.

The wafer is scanned under the illuminating area, usually in an R-θ scanning mode whereby the entire wafer surface is scanned in a spiral pattern. The capability of inspection systems to detect defects is usually calibrated by their ability to detect known sizes of polystyrene latex (PSL) spheres on silicon wafers. Examples of optical inspection systems for unpatterned wafers can be found in U.S. Pat. Nos. 4,314,763 (Steigmeier et al), 5,343,290 (Batchelder et al.), 5,861,952 (Tsuji et al.), 6,081,325 (Leslie et al.), and 6,271,916 (Marxer et al.), which are all incorporated herein for all purposes by reference.

An analysis of light scattering from particles smaller than 200 nm on silicon wafers reveals that the scattering from the particles is predominantly Rayleigh scattering, and thus varies as d⁶/λ⁴ (where d is the particle diameter and λ is the laser wavelength). In addition, the best sensitivity for such small particles is obtained with p-polarized light that is incident between 45°-65° relative to the wafer surface normal. For particles, scattering is preferentially at fairly large polar scattering angles relative to the wafer surface normal, while for pits it is preferentially at small polar scattering angles.

Current systems used for micro-defect inspection on unpatterned wafers typically use laser radiation at wavelengths lower than 500 nm and incident at about 60°-70° with p-polarization. The laser light is focused down to an illuminated spot in the form of a stripe that is about 25×50 μm in size where the 50 μm length is in the radial R direction of the R-θ scan. This means that a particle or defect is detected as it traverses the width of the illuminated stripe at the wafer surface. The light scattered from the surface of the wafer is typically collected by two separate collectors. One collector, which is typically a reflective elliptical collector with axis of symmetry normal to the wafer, collects scattered light over a polar range of 25°-70° relative to the wafer surface normal and over an azimuthal angle range of close to 360°, a configuration that is more sensitive for particle detection. A second collector, which is typically a low-NA lens, collects light from 0° to 25° relative to the wafer surface normal, and is more sensitive for pit detection. Some current systems use UV or DUV lasers with wavelengths such as 355 nm or 266 nm. This has two major advantages: it provides greater sensitivity thanks to the 1/λ⁴ effect, and it also eliminates interference effects from underlying layers when working with engineered wafers such as SOI and SIMOX, because thin epitaxial Si is opaque at both wavelengths.

Current systems are able to detect micro defects larger than 35 nm with a 95% defect capture rate and less than 1 ppm false counts at a throughput of 60 wph. However they have considerable difficulties in detecting particles smaller than 35 nm at the required performance specifications. The marginal performance of current systems at 35 mm will become much worse at the smaller defect levels of the 32 nm technology node and at future IC generations.

In micro-defect inspection of unpatterned wafers, the major sources of light scatter are surface micro-roughness (i.e. haze), illumination beam induced Rayleigh scatter from ambient air and localized defects such as particles, pits, scratches, etc. Haze is an area scatter effect since it comes from everywhere on the wafer surface and varies relatively slowly with wafer position. Rayleigh scatter is a volume scatter effect since it comes from the illuminating volume and it also varies relatively slowly with wafer position. In contrast, localized defects can be considered as transient point scatterers as they traverse the width of the illumination stripe at the wafer surface. As the design rules move to smaller dimensions, it becomes necessary to detect ever smaller point defects. Even though surface quality also improves with the smaller design rules, it becomes more and more difficult to detect these smaller point defects in the presence of haze at a reasonable wafer throughput. This is primarily a result of the fact that the amount of light scattered by a point defect, that is smaller than the wavelength of the laser light, varies as d⁶ where d is the diameter of the defect, and thus the scatter signal from a point defect decreases rapidly with decreasing defect size. On the other hand, the amount of light scattered by surface micro-roughness varies only as σ² where σ is the rms roughness of the surface. Thus even if σ decreases at the same rate as d, the haze signal falls off much less rapidly than the particle signal as the design rules decrease. Furthermore, the haze signal comes from the entire illuminated area (25×50 μm stripe in current systems), while the point defect signal essentially comes only from a diffraction-limited spot, typically 1 μm, within the illuminated area. Thus for many wafer surfaces, particularly those that have films or layers, the haze signal is generally much larger than the particle signal, and this difference in the strengths of the two signals increases rapidly as the design rules decrease.

There is an additional background signal that comes from ambient Rayleigh scattering of the incident laser light. This is the result of scattering from the air molecules in an air volume above the wafer surface that is defined in area by the field of view of the collecting optics and in depth by the distance parallel to the normal to the wafer surface that is traversed by the incident and reflected laser beams. Although this background signal is usually smaller than the haze signal, it is not insignificant.

Thus there is a continuing need to develop a more sensitive optical inspection system for samples such as unpatterned wafers that can meet some or all of the inspection criteria of future design rules (e.g. 95% defect capture rate, <1 ppm false counts, 60 wph throughput at the 32 nm technology node and beyond, etc.).

### SUMMARY OF THE INVENTION

The present invention solves the aforementioned problems by providing a system and method for improved particle detection, which more reliably detects particles of smaller size with high throughput than conventional systems.

An inspection system for inspecting a sample surface includes a light source for generating a probe beam of light, one or more first optical elements for focusing the probe beam onto a sample surface, wherein the sample surface scatters the light forming a scattered probe beam that is captured by the one or more first optical elements, one or more second optical elements for imaging the scattered probe beam onto a detector, wherein the detector includes a plurality of detector elements that generate output signals in response to the scattered probe beam, and a processor for analyzing the output signals to identify defects on the sample surface.

In another aspect, an inspection system for inspecting a sample surface includes a light source for generating a probe beam of light, one or more first optical elements for focusing the probe beam onto a sample surface via normal incidence illumination, wherein the sample surface scatters the light forming a scattered probe beam that is captured by the one or more first optical elements, and wherein the one or more first optical elements has an effective focusing NA for the probe beam of at least 0.5, one or more second optical elements for directing the scattered probe beam onto a detector that generates output signals in response to the scattered probe beam, and a processor for analyzing the output signals to identify defects on the sample surface.

In yet another aspect, an inspection system for inspecting a sample surface includes a light source for generating a probe beam of light, one or more first optical elements for focusing the probe beam onto a sample surface via normal incidence illumination, wherein the sample surface scatters the light forming a scattered probe beam that is captured by the one or more first optical elements, one or more second optical elements for directing the scattered probe beam onto a detector, one or more third optical elements for directing a reference beam to the detector, wherein the detector generates output signals in response to the scattered probe beam and the reference beam, and a processor for analyzing the output signals to identify defects on the sample surface.

A method of inspecting a sample surface includes generating a probe beam of light, focusing the probe beam onto a sample surface using one or more first optical elements, wherein the sample surface scatters the light forming a scattered probe beam, capturing the scattered probe beam with the one or more first optical elements, imaging the scattered probe beam onto a detector, wherein the detector includes a plurality of detector elements that generate output signals in response to the scattered probe beam, and analyzing the output signals to identify defects on the sample surface.

In yet another aspect, a method of inspecting a sample surface includes generating a probe beam of light, focusing the probe beam onto a sample surface via normal incidence illumination using one or more first optical elements, wherein the sample surface scatters the light forming a scattered probe beam, and wherein the one or more first optical elements has an effective focusing NA for the probe beam of at least 0.5, capturing the scattered probe beam with the one or more first optical elements, directing the scattered probe beam onto a detector, wherein the detector generates output signals in response to the scattered probe beam, and analyzing the output signals to identify defects on the sample surface.

In still yet another aspect, a method of inspecting a sample surface includes generating a probe beam of light, focusing the probe beam onto a sample surface via normal incidence illumination using one or more first optical elements, wherein the sample surface scatters the light forming a scattered probe beam, capturing the scattered probe beam with the one or more first optical elements, directing the scattered probe beam onto a detector, generating a reference beam, directing the reference beam to the detector, wherein the detector generates output signals in response to the scattered probe beam and the reference beam, and analyzing the output signals to identify defects on the sample surface.

Other objects and features of the present invention will become apparent by a review of the specification, claims and appended figures.

### BRIEF DESCRIPTION OF THE DRAWINGS

FIG. 1 is a diagram illustrating prior art using oblique illumination and large solid angle elliptical scatter collection optics.

FIG. 2 is a diagram illustrating prior art using normal incidence illumination below the collection optics and large solid angle scatter collection optics.

FIG. 3 is a diagram illustrating prior art using normal incidence illumination through the large solid angle scatter collection optics.

FIG. 4 is a diagram illustrating the optical configuration of the disclosed surface inspection system.

FIG. 5 is a diagram illustrating an alternative optical configuration of the surface inspection system.

FIG. 6 is a diagram illustrating the probe beam stripe incident on the entrance aperture of the focusing lens offset from the center of the lens.

FIG. 7 is a diagram illustrating the range of probe ray angles onto a wafer surface from a probe beam stripe incident on the focusing lens offset from the center of the lens.

FIG. 8 is a diagram illustrating the optical configuration of the surface inspection system.

FIG. 9 is a diagram illustrating the use of an area array scattered light detector.

FIG. 10 is plot of data taken from a lab system using the optical configuration of the surface inspection system and from a lab system with illumination and collection optics similar to prior art systems.

FIG. 11 is a diagram illustrating the optical configuration of the surface inspection system with heterodyning.

FIG. 12 is a diagram illustrating the optical configuration of the surface inspection system with homodyning.

FIGS. 13A-13D are data plots illustrating the haze reduction possible with interferometric detection (e.g. heterodyning).

FIG. 14 is a plot of data showing the ratio of heterodyne to no-heterodyne S/N versus haze for several particle sizes of interest.

FIG. 15 is a plot showing theoretical and experimental results of the ratio of heterodyne to no heterodyne S/N versus particle size for a range of haze values.

FIG. 16 is a plot showing theoretical minimum detectable particle size versus haze for current prior art technology and for the optical configuration of the disclosed surface inspection system.

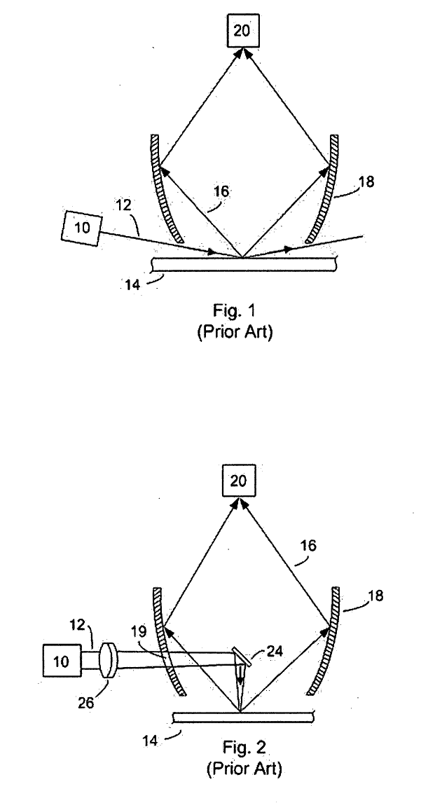

### DETAILED DESCRIPTION OF THE PREFERRED EMBODIMENTS

Described herein is a high-sensitivity wafer inspection system and method that provides improved surface detection accuracy and throughput. An optical configuration of the system is illustrated in FIG. 4. A collimated light source 10 (e.g. a laser source) produces a probe beam 12, which is shaped by lens assembly 32. Probe beam 12 passes through (or around) a spatial filter 46 (preferably positioned at the Fourier plane of lens 36). Probe beam 12 is shaped by lens assembly 32, into a narrow ellipse 34 at the entrance pupil of lens 36. The narrow ellipse 34 may be offset from the center axis of lens 36 to increase the angles of incidence for the probe beam onto the wafer. Lens 36 then focuses the probe beam 12 onto a sample surface 14 in the form of an illuminated stripe 38. For clarity, the illuminated stripe 38 is illustrated in larger size as 40. The long axis of stripe 38 is radial to the wafer as shown by 40. The specularly reflected illumination beam 42 from the sample surface 14 is collected by lens 36, and then passes through (or around) spatial filter 46, and is finally collected by beam dump 44.

Light scattered from sample surface 14 is also collected by lens 36 in the form of a scattered probe beam 16, and is directed to image relay lens 50 by spatial filter 46. Spatial filter 46 illustrated in FIG. 4 is a reflective mirror that is sized and is preferably positioned in the Fourier plane of lens 36 to reject (pass) the majority of reflected specular light while directing (reflecting) the majority of the scattered light. The simplest configuration is to size spatial filter 46 such that beam 12 and the majority of reflected specular light pass by (go around the edges of) the mirror, while the majority of the scattered light collected by lens 36 is reflected toward detector 52.

Image relay lens 50 images the illumination stripe 38 onto a multi-element detector 52, having a plurality of detecting elements or pixels 53. The detector 52 generates an electrical signal in response to the detected light, which is sent to a processor 54. The electrical signals generated by the detector pixels 53 are composites of several signals, including transient signals generated by point defects (point defect signals) as well as background signals (e.g. haze and ambient Rayleigh scatter). An optional adjustable incident beam polarizer 30 provides a means to improve scatter light intensity which is a function of incident polarization. An optional adjustable collected scatter light polarizer 48 provides a means to improve the scatter signal to noise ratio, for example, by rejecting incident polarizations (i.e. polarizers 30 and 48 are oriented in a cross polarizer configuration). A rotating chuck 60 firmly holds the sample 14 and is used to spin the sample. The chuck 14 is rotated by rotary stage 62. Either the rotary stage 62 is translated by linear stage 64, or the lens 36 and its associated optics translate probe beam 12, so that the illuminated spot can be scanned across the entire wafer surface in a spiral pattern. FIG. 4 shows an off-axis illumination configuration.

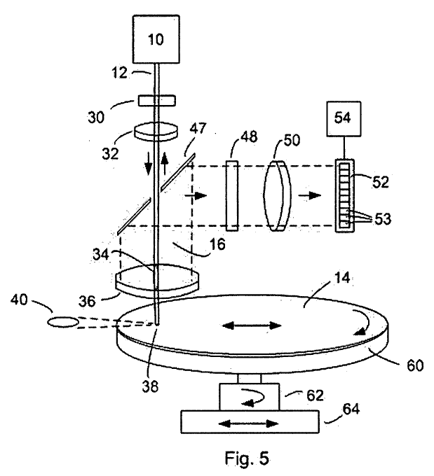

An alternate optical configuration of the system is illustrated in FIG. 5. The system illustrated in FIG. 5 is very similar to the system in FIG. 4 with two primary differences. The probe beam 12 is directed to the center of lens 36 (on-axis instead of off-axis illumination), and a modified spatial filter 47 (e.g. a mirror with a central aperture) passes both incident and specular reflected beams through its center (instead of the beam passing on either side the filter). Spatial filter 47 is also preferably in the Fourier plane of lens 36 and serves to reject the majority of reflected specular light (through an aperture in the center) while directing (reflecting) the majority of the scattered light toward the detector 52. This on-axis configuration, with normal incidence illumination, may provide higher sensitivity to certain types of defects, such as micro-scratches and EPI slip lines.

It should be noted that a system could be configured to combine both on-axis and off-axis capability. The user would be able to select either configuration. The spatial filters 46, 47 and the position of the illumination spot 34 onto lens 36 would be user-selectable with appropriate opto-mechanical mechanisms implemented to facilitate the movement of the beam position relative to lens 36 and spatial filter selection. Such opto-mechanical mechanisms are well known to one skilled in the art.

The haze signal can be considered as a DC background signal upon which is superimposed some transient pulses representing the point defect scatter signals. The detector converts these various scattered light signals into electrical currents. To detect the point defect current signals, iₚ, in the presence of the haze current signal, iₕ, it is important that the point defect current signal, iₚ, be greater than the peak-to-peak magnitude of the shot noise from the haze signal, i.e., iₚ>3(iₕ)ₙ, where (iₕ)ₙ is the rms shot noise from the haze signal and is given by,
(iₕ)ₙ=(2qBiₕ)^{1/2} (1)
where q is the electron charge and B is the measurement bandwidth. For a defect capture rate of 95% and a false count of <1 ppm, iₚ should be greater than about 6(iₕ)ₙ. A typical industry value, under the condition where the primary noise source is the shot noise from the haze signal, is that iₚ>8(iₕ)ₙ. As stated earlier, the signal from the point defects decreases much faster than the signal from the haze as the design rule decreases. Thus, since iₚ decreases much faster than iₕ, the criterion that iₚ>8(iₕ)ₙ becomes ever harder to fulfill as the design rules decrease.

There are a number of improvements described herein that can be employed to mitigate this situation, including 1) increase the intensity of the light by reducing the area of the illuminated spot on the wafer, 2) achieve acute angle incidence rays with normal incidence illumination beam, 3) utilize cross polarization, 4) image the light from the sample onto a multi-element array detector, 5) employ interferometric detection techniques such as homodyne or heterodyne detection.

Reduced Illumination Area

Changing the optical intensity (power per unit area) of the probe beam 12 at the wafer through modifications in the size and/or shape of the illuminated spot on the wafer can dramatically increase sensitivity. The relative scattering power from a point defect varies directly as the laser intensity incident on the defect. Thus, for a constant laser power, iₚ will increase as the illumination light intensity increases, that is, as the illumination area decreases. On the other hand, the relative scattering power from haze, and thus iₕ, is dependent only on laser power and is independent of the illumination area. Thus decreasing the illumination area increases the scattering from the defect thereby increasing the defect signal but does not affect the scattering from haze and thus does not change the noise. Since the rotation frequency of a 300 mm wafer is typically limited to about 100 Hz, it is preferable to maintain the length of the illumination stripe on the wafer surface to at least 25 to 50 μm. Thus a meaningful decrease in illumination area requires a sizable decrease in the width of the stripe. This then implies a large length/width aspect ratio for the stripe. An aspect ratio of at least 5 is preferred. However, it is very difficult in practice to decrease the illumination spot size below 10×50 μm when the probe beam is directed at the wafer through focusing optics separate from the scatter collection optics, at a fairly large angle of incidence, such as 60°-70°, as is commonly done now.

One method to achieve a much smaller illumination area is to utilize “normal incidence illumination” (which means that the probe beam 12 enters the focusing lens 36 in FIG. 4 at an angle generally normal to the wafer surface). Normal incidence illumination is an option in some current inspection systems, but in these systems the illumination is through a relatively low-NA lens, which makes it difficult to achieve a small illuminated area at the wafer surface. Ideally, the probe beam spot at the wafer should be an elongated stripe, with the long direction of the stripe oriented in the radial direction of the spinning wafer (i.e. perpendicular to the wafer spin direction such that more of the wafer can be inspected in each revolution for better throughput), and the short direction of the stripe oriented parallel to the spin direction of the wafer. Ideally, the chuck 60 translates the sample 14 in the same direction as the length direction of the stripe, in order to create the spiral scan pattern over the sample surface. Preferably, the length of the stripe at the wafer surface, which is in the R-direction of an R-θ spiral scan, is at least 25 μm, and preferably closer to 50 μm. The length can be greater than 50 μm to increase throughput by covering more wafer area per rotation. However, the width of the stripe can be significantly reduced to increase illumination intensity, thus significantly increasing sensitivity. To achieve a stripe-shaped illuminated area using normal incidence illumination, the entrance pupil of the high-NA lens 38 is itself illuminated with a stripe of light obtained by first passing the probe beam through suitable beam shaping optics 32, which shape the probe beam into a stripe shape at the wafer surface 14. In order to achieve strong focusing, the length of the stripe should cover most of the length of the aperture at the position of the stripe. With a suitable choice of beam shaping optics 32, a stripe length at the wafer surface of 50 μm can be maintained but the stripe width at the surface can be reduced from 25 μm to a diffraction-limited value of about 1 μm. Since the area of a 1×50 μm spot is 25 times smaller than the 25×50 μm spot currently used, the illumination intensity (and thus the scattering power from the defects) has been increased by a factor of 25×.

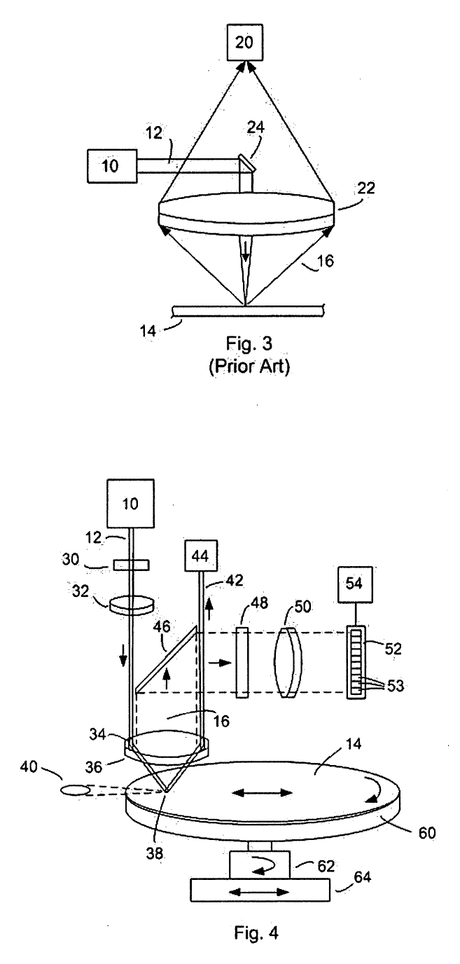

Another advantage of using a high-NA lens with normal incidence illumination is that the lens 36 can also be used as a highly efficient collector of the scattered light. For an NA>0.7, collection efficiencies of the scattered light can be achieved that are comparable to the large elliptical reflective collectors used in current systems. Using a lens with an NA of 0.95, probe rays may be generated with incidence angles that range from 0° to 72°, while scattered rays are collected over the same range of polar angles and over the full 2π azimuthal angles. This is a very efficient scattered light collector with a solid collection angle >4 steradians (which is comparable to the collection solid angles of current inspection systems that employ large elliptical reflective collectors for the scattered light). Although an example of a lens with an NA of 0.95 is described, lower NA lenses can also be used as a “high NA lens” described herein, so long as the NA is at least 0.5 (which gives a collection solid angle of about 0.8 steradians). The use of a single high-NA lens for both illumination and collection has been employed previously, but in the prior art, the illumination does not utilize the high-NA nature of the lens. Instead the probe beam illuminates only a small central region of the high-NA lens and the radius of the probe beam at the lens aperture is much smaller than the radius of the aperture (see FIG. 3). This means that the lens in the illumination phase acts effectively as a low-NA lens and the illuminated spot at the wafer surface has a relatively large area. In the prior art, the high-NA nature of the lens is only utilized during the collection phase of the scattered light. As described below, utilizing a high effective focusing NA of the lens (by utilizing more of the full diameter of the high-NA lens) has advantages.

Yet another advantage of using a high-NA lens for normal incidence illumination is increased immunity to ambient Rayleigh scatter from the air. The field of view through the high NA lens can be reduced to the size of the illumination area at the wafer surface. Furthermore, if the lateral field of view is limited by an aperture in the confocal plane, further reduction is possible in the ambient Rayleigh signal due to the confocal reduction in the vertical field of view as well. Current inspection systems cannot limit lateral or vertical fields of view as well due to poor illumination area imaging by large elliptical reflective collectors.

High Angles of Incidence with Normal Incidence Illumination

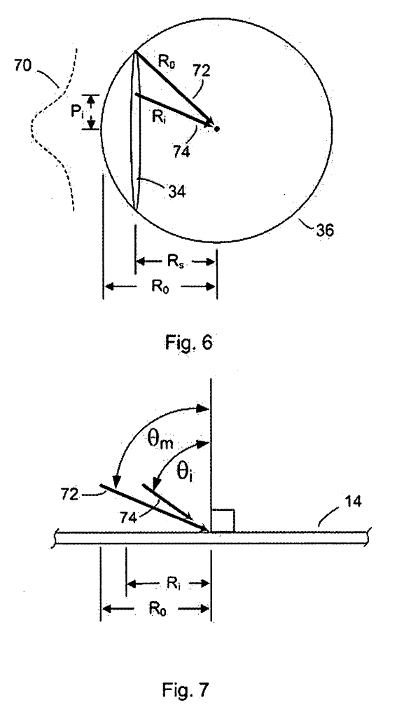

A major change that occurs when illuminating at normal incidence through a high-NA lens rather than at an oblique angle is that the single angle of incidence that is present when illuminating at an oblique angle is now replaced by a range of angles of incidence. Referring to FIGS. 6 and 7, the angle of incidence, θᵢ, at the wafer surface of a ray, i, emanating from a position, Pᵢ, on the stripe at the lens aperture is given by,

$${θ}_{i} = {sin}^{- 1} ( \frac{{R}_{i}}{{R}_{0}} NA ) \qquad ( 2 )$$

where Rᵢ is the distance of Pᵢ from the center of the lens and R₀ is the radius of the lens aperture. If the stripe at the entrance pupil of the high-NA lens is centered along the lens diameter, and the stripe length at the center is close to the aperture diameter, then the angles of incidence within the stripe at the wafer surface will range from 0° to a maximum angle of approximately θₘ=sin⁻¹(NA). For a lens with an NA of 0.95, θₘ=72°, and thus the incidence angle range is now 0° to about 72°. However, the effect of the Gaussian profile 70 of the probe beam must also be considered. The laser Gaussian profile will concentrate most of the light power at the entrance pupil near the center of the lens 36. Thus, most of the light power will have incidence angles at the surface typically <30°. This configuration may be advantageous for some applications that prefer more normal rather than oblique illumination, such as detection of micro-scratches and epitaxial silicon defects.

However, for most micro-defect inspection applications, most of the light power at the entrance pupil should be at larger angles of incidence, typically 45°-65°, because the scattering cross-section for particles smaller than 100 nm increases with increasing angle of incidence up to about 65°. Larger angles of incidence, even with the laser Gaussian profile 70, can be achieved with normal incidence illumination by displacing the light stripe at the entrance pupil to one side of the lens 36 (i.e. away from the center of the lens), as illustrated in FIGS. 6 and 7. R₀ is the radius of the entrance pupil of lens 36, and Rₛ is the distance from the center of the lens to the center of the stripe 34. If the length of the off-set stripe is approximately the length of the chord of the aperture at the position of the stripe, then the stripe at the wafer surface will have incidence angles ranging from θₛ to approximately θₘ where θₛ=sin⁻¹[(Rₛ/R₀)NA]. If the length of the stripe at the lens aperture is close to the length of the chord of the aperture at the position of the stripe, then the effective focusing NA for the illumination is close to the actual NA of the lens. In the prior art where the probe beam only fills the center region of the lens aperture (see FIG. 3), all distances Rᵢ from the illuminated area at the aperture to the center of the lens are <<R₀ (the radius of the lens), and the effective focusing NA for the illumination is much smaller than the actual NA of the lens. This is not the case in the present embodiment. Thus, for example, for a lens with an NA of 0.95 and where the stripe at the entrance pupil is displaced such that (Rₛ/R₀)=0.75, then θₛ=45°, and the theoretical incidence angle range is now 45° to about 72°. Again the effect of the probe beam Gaussian profile 70 will be to concentrate most of the light power in the range of 45°-55°. This is adequate since the differential scattering cross-section does not change much between an angle of incidence of 45° and 65°. Although an example of a lens with an NA of 0.95 is used, lower NA lenses can also be used to create a high effective focusing NA (e.g. a lens with an NA of 0.5 can still provide a range of angles of incidence of 22°-30° when the beam is displaced well off center of the lens). The displacement of the probe beam to one side (i.e. away from the center of the lens) does not significantly alter the length of the stripe at the wafer surface, while the stripe width remains in the 1 μm range for a light wavelength of 532 nm or lower.

The key to achieving such a narrow illumination stripe on the wafer surface is to illuminate the aperture of the high-NA lens with a stripe whose length is approximately the length of the chord of the aperture at the position of the stripe. This ensures that the rays from the maximum angles of incidence will be close to θₘ=sin⁻¹(NA). As mentioned above, the minimum NA that is adequate for this application is 0.5, which can still produce a fairly thin stripe on the surface of 2-3 μm width, but a marginal collection solid angle of 0.8 steradians. Any lower NA lens is disadvantageous, not only because it would result in a larger illumination area at the wafer surface but also because the collection solid angle of the scattered radiation decreases rapidly for an NA smaller than 0.5. If a lens with an NA greater than 0.5 is used in order to increase the collection solid angle, the effective focusing NA of the probe beam should still be at least 0.5. In the present embodiment, a high NA lens (0.95 NA) is used to ensure that the effective focusing NA is also quite high (>0.9 NA) by using an appropriately long stripe at the lens aperture.

Cross Polarization

Using normal incidence illumination through a high-NA lens introduces another source of background optical signal and thus noise in addition to the haze and ambient Rayleigh background signals. This new source of background signal is the specular reflection from the wafer surface and from optical elements in the probe beam path that are directed back towards the detector. Much of this specular background can be removed by using spatial filters 46 or 47 which reflects the scattered probe 16 and allows the specular reflected probe 42 beam to pass through. As described above, this can be done with the use of a suitable spatial filters 46, 47 preferably in the Fourier plane of the lens 36, combined with various beam stops in the light path.

To remove most of the remaining specularly reflecting light, optional crossed polarizers can be used. For example, if the light incident on the lens is p-polarized (e.g. by placing a linear polarizer 30 in probe beam 12), a cross polarizer 48 (e.g. linear polarizer 48 oriented generally orthogonally to linear polarizer 30) is placed in the scattered probe beam path so that only s-polarized light reaches the detector 52 (see FIG. 4). A p-incident and s-detecting configuration can also lower the haze background. It should be noted that while the use of crossed polarizers will greatly attenuate the specular background and can also reduce the haze background, it does not necessarily significantly attenuate the scattered light from the micro defects, since this scattered light is collected by the high-NA lens 36 at all polar and azimuthal angles and exits the lens 36 with both s and p polarization components. For the case of p-polarized incident light and an illumination stripe at the center of the lens entrance pupil, the exiting scattered light is evenly divided between s and p polarized components. For the case of p-polarized incident light and an illumination stripe offset from the center of the lens entrance pupil such that (Rₛ/R₀)=0.75, the s-polarized component in the exiting scattered light is actually greater than the p-polarized component. By using the crossed polarizers, the specular background signal can be reduced to the extent that for most wafers the most significant background signal is still the haze (i.e. the scattered light from the wafer surface micro-roughness).

Stray Light Reduction

Stray light reduction is also important to maximize signal to noise. Optical components can be optimized to reduce stray light scatter by using highly efficient anti-reflection coating(s) tuned to the laser wavelength (known as V coatings). Optical components can also be made from materials that have minimal internal scatter by reducing impurities, bubbles, etc. Optical components can also be manufactured with ultra-smooth surfaces to further reduce scatter. Stray light baffles can be used to further reduce remaining stray light.

Detector Array

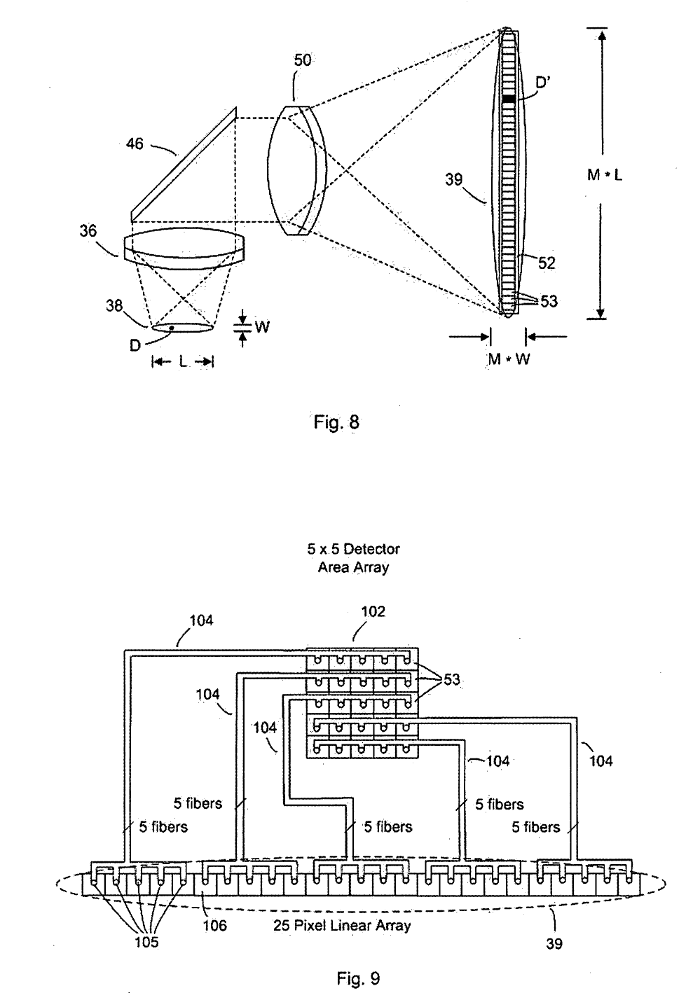

In current systems employing the large elliptical reflective collectors, the scattered light is directed to a single-element detector such as a photomultiplier tube (PMT). The effects of haze from the wafer surface, of ambient Rayleigh scattering from the air and of any residual specular light from the wafer surface and from the surface of optics in the probe beam light path can be reduced further by using a multi-element array detector, such as a PMT array, an avalanche photodiode array or a fast photodiode array, located in an image plane of the high-NA lens where the illuminating stripe is imaged. Preferably a linear array detector is used with the array length oriented parallel to the stripe length, as illustrated in FIG. 8. It is important that the imaging optic(s) image the scattered probe beam such that there is a one-to-one correspondence between locations along the illumination stripe at the wafer surface and the pixel elements 53 of the linear detector array 52. The illuminated stripe at the wafer surface 38 is imaged onto the detector array by a suitable choice of imaging optics 50, to form a magnified image 39 at the plane of the detector 52. The image magnification M is chosen so the size of each pixel 53 of the detector 52 corresponds to its relative area in the illuminating stripe 38 on the wafer so that there is a one-to-one correspondence between locations on the stripe at the wafer and corresponding detector pixel elements 53. A defect D in the illuminated stripe at the wafer surface is thus imaged as defect image D′ at the detector 52. Furthermore, each detector element 53 preferably has a size of the order of the diffraction-limited image of a micro defect at the image plane. If this is the case, then a micro defect would affect at most only two of the detector elements 53. If there are N detector elements 53, then while the recorded magnitude of the defect scatter signal is unaltered, the recorded magnitudes of any optical background signals from haze, ambient Rayleigh or specular reflections are reduced by N/2 by the Nyquist sampling rule, and the shot noises from these background optical signals are reduced by (N/2)^{1/2}. It is important to note that the elliptical reflective collectors used in current particle detection systems cannot properly image the illuminated stripe from the wafer onto a detector array, and thus cannot reduce the noise from the haze or other background optical signals by this imaging process.

A two-dimensional detector array 102 can also be used (as illustrated in FIG. 9), where the image of the stripe is first split into segments with suitable optics, for example, optical fibers 105 where each segment is then imaged sequentially onto the linear segments of the two-dimensional detector array 102. In FIG. 9, there are twenty-five fibers arranged in five groups 104 of five optical fibers each, with their respective outputs mapped to individual pixels elements of a 5×5 detector array 102. The inputs to the twenty-five fibers are aligned in a linear fashion 106 to match the aspect ratio of the imaged stripe 39.

It is not the DC values of the background optical signals that is of most concern, but rather the broadband shot noise associated with these signals. Thus, the measurement bandwidth should also be considered. When the width of the stripe at the wafer surface is reduced by 25×, the transit time of the particle across this stripe is also reduced by 25×. Thus the measurement bandwidth is increased by 25×. This will increase the shot noise by 5× (see Eqn (1)).

There is a significant theoretical signal/noise improvement obtained by going from the conventional configuration (i.e. illuminating the wafer with a probe beam directed by optics external to the collection optics at an oblique angle of incidence and detecting the scattered light using a single-element detector) to the configuration described above (i.e. the probe beam illuminates the wafer using normal incidence illumination through a high-NA lens, and the same high NA lens images the scattered light from the narrow stripe on the wafer surface onto an N-element detector array). The signal from the micro defect will increase by 25× in the new configuration, with a 25× smaller illumination area, provided that the two configurations have similar light collection efficiencies. If N=50 in the multi-element detector array, the haze signal recorded by the one to two elements that have recorded the particle signal is now only 1/25 of the total haze signal from the entire stripe and thus the haze shot noise will remain the same, even though the measurement bandwidth has increased by 25× (see Eqn. (1)). Thus, the configuration described above will have a net signal/noise improvement over the conventional configuration of about 25×. This significant increase in signal/noise can enable this new high-sensitivity system and technique to detect much smaller particles than the current systems. FIG. 10 shows experimental results for the measured signal/noise ratios for two laboratory particle detection systems as a function of particle size. The data and curve labeled “Conventional” is for a lab system using conventional technology whereby the probe beam is focused by a relatively low-NA lens and is incident on the wafer surface at 60° producing an illuminated area of 25×50 μm at the wafer surface. The scattered light is collected by a high-NA collector and directed to a single-element PMT. The data and curve labeled “Invention” is for a lab system with the disclosed technology, whereby the probe beam is first shaped by a beam shaping assembly and then directed at normal incidence at a high-NA lens which focuses an offset stripe at the lens aperture to form a narrow 1×50 μm stripe on the wafer surface. The scattered light is then collected by a high-NA lens and imaged onto an apertured single-element PMT array which simulates a single channel of a multi-element array. The two systems have the same laser power on the wafer and the same illuminating p-polarization. Indeed the system with the disclosed technology has an improvement in the signal/noise ratio for all particle sizes measured of about 25×, as predicted by the above analysis.

Homodyne/Heterodyne Detection

Above is described a direct measurement of the scattered light from point defects that is very advantageous when the haze signal is very low. However, as shown in more detail in the section Signal/Noise Ratios below, when the haze signal iₕ>¼iₚ, a better signal/noise ratio can be obtained by employing interferometric detection means, such as homodyne or heterodyne detection. Heterodyne and homodyne techniques and related calculations are known, as illustrated by U.S. Pat. Nos. 5,343,290 (Batchelder et al.) and 5,923,423 (Sawatari et al.), which are incorporated herein by reference.

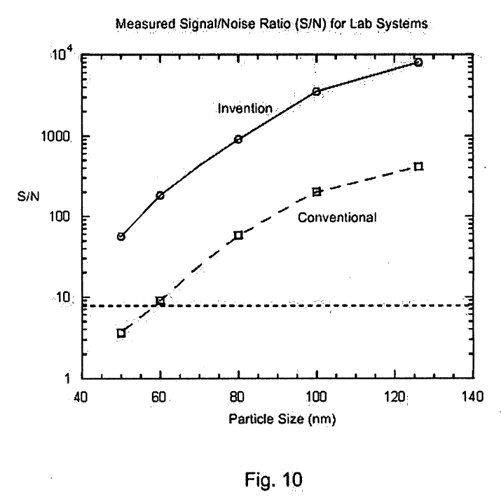

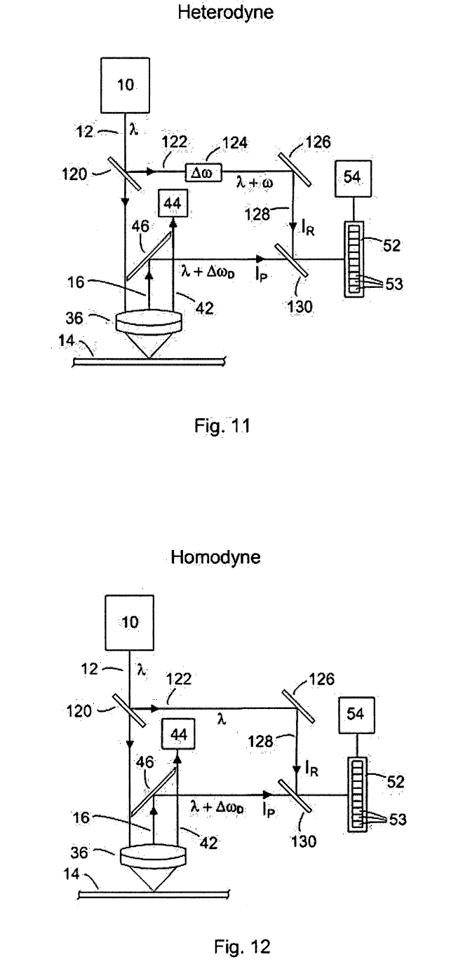

These detection techniques are known, and involve mixing the scattered probe beam 16 from the wafer surface with a reference beam 128 that is generally coherent with the probe beam. In heterodyne detection, as illustrated in FIG. 11, the reference beam 128 has a slightly different optical frequency than the probe beam 12. In the heterodyne configuration, if the probe beam 12 from a light source 10 has an optical frequency c, a coherent reference beam 128 can be generated with an optical frequency ω+Δω by picking off a portion of the probe beam 12 using a beam splitter 120 and sending it through an acousto-optic modulator (AOM) 124, or other suitable frequency shifter, operating at a frequency Δω. This reference beam 128 is then combined with the scattered probe beam 16 at the detector 52 using a beam combiner 130. In homodyne detection, as illustrated in FIG. 12, the reference beam 128 has the same optical frequency as the probe beam 12. For example, the configuration of FIG. 11 can be used, but without the AOM 124, as shown in FIG. 12. In the case of stationary illuminated objects, homodyne detection generally is not as useful as heterodyne detection because of phase noise. However, in the case of spinning wafers, homodyne detection can be useful because the frequency of most of the scattered probe beam 16 will have been Doppler shifted by the moving sample surface, and thus portions of the two beams 16/128 will have different optical frequencies.

As long as the reference beam power on a detector element is greater than the scattered power from either the point defect or the haze (and other background signals), the interferometric approach can provide a superior signal/noise ratio. Note that if cross polarizes are used, then it is preferable that the polarization of the reference beam be rotated by 90 degrees, for example by a half wave plate, so that the polarizations of the reference beam and the signal beam are the same at the detector surface in order to get an optimal interference.

In the absence of any Doppler shifts, the signal at the detector 52 will be given by,
I_{d}=|Eₚ|²+|Eₕ|²+|Eᵣ|²+2|Eₚ∥Eᵣ|cos Ψᵣ(t)+2|Eₚ∥Eₕ|cos Ψᵣ(t)+shot−noise terms (3)
where Eₚ, Eₕ and Eᵣ are the optical fields for the scattered defect beam, the scattered haze beam and the reference beam 128, respectively, and t is time. Here it is assumed that the haze signal is the dominant background signal. The phase fluctuation Ψ(t) arises from the inevitable fluctuations in the optical path lengths between the particle and haze signal beams and the reference beam, respectively. The two interference terms are basically two DC terms that are generally smaller than the DC term from the reference beam, and in addition are very noisy because of the phase fluctuations. However, the scattered photons will generally exhibit some Doppler shift because the R-θ scan imparts a velocity to the scattered light from the illuminated stripe relative to the reference beam.

In the presence of a Doppler frequency shift Δω_{D}, the homodyne signal is given by,

$${I}_{d} = {\vert {E}_{p} \vert}^{2} + {\vert {E}_{h} \vert}^{2} + {\vert {E}_{r} \vert}^{2} + 2 \vert {E}_{p} \vert \vert {E}_{r} \vert cos ( Δ {ω}_{D} t + {ψ}_{r} ( t ) ) + 2 \vert {E}_{h} \vert \vert {E}_{r} \vert cos ( Δ {ω}_{D} t + {ψ}_{r} ( t ) ) + shot - noise terms \qquad ( 4 )$$

Here, the two interference terms are now AC terms and this allows for AC coupling of the signal, which in turn allows for easier detection of the interference terms. Furthermore, as long as the measurement time τ>2π/Δω_{D}, and as long as the fluctuations in Ψᵣ(t) are slow relative to τ, then the total phase will go through at least one full 2π cycle during the measurement time, where a suitable electronic circuit such as a rectifier or a magnitude-reading PSD (phase-sensitive detector) can then be used to obtain a stable and repeatable measure of the interference signal.

The Doppler frequency shift can be written as,

$$Δ {ω}_{D} = f ( {θ}_{i} , {θ}_{s} , {φ}_{s} ) \frac{d}{λ} Δ {ω}_{τ} \\ Δ {ω}_{τ} = 2 π \frac{v}{d} \qquad ( 5 )$$

where θᵢ, θₛ, φₛ represent the incident angle, the polar scatter angle and the azimuthal scatter angle respectively, d the width of the stripe on the wafer surface, λ the laser wavelength, ν the particle velocity across the stripe, and Δω_{τ} is the stripe transit frequency. The absolute magnitude of the function ƒ can range from 0 to 2 depending on the incident and scattering angles. For most scattering events Δω_{D} will be,

$$Δ {ω}_{D} \approx \frac{d}{λ} Δ {ω}_{τ} = 2 π \frac{v}{λ} \qquad ( 6 )$$

Since the measurement occurs during a time interval that spans t=0 to t=τ=d/ν, Δω_{D}t goes from 0 to 2πd/λ. Since d>λ, Δω_{D}t will sweep through at least 2π and this then ensures that a rectifier will provide a stable output for the interference term irrespective of Ψᵣ(t) which is changing slowly relatively to τ.

One can also obtain a stable interferometric signal by means of heterodyne detection. The heterodyne signal is given by,

$${I}_{d} = {\vert {E}_{p} \vert}^{2} + {\vert {E}_{h} \vert}^{2} + {\vert {E}_{r} \vert}^{2} + 2 \vert {E}_{p} \vert \vert {E}_{r} \vert cos ( Δ ω t + Δ {ω}_{D} t + {ψ}_{r} ( t ) ) + 2 \vert {E}_{h} \vert \vert {E}_{r} \vert cos ( Δ ω t + Δ {ω}_{D} t + {ψ}_{r} ( t ) ) + shot - noise terms \qquad ( 7 )$$

where Δω is the frequency shift imparted to the reference beam 128 of FIG. 11 by a suitable frequency modulator such as the AOM 124. Alternately, one can impart the frequency shift to just the probe beam 12, or to the scattered probe beam, or even impart frequency shifts to both beams 12/128, so long as the two optical frequencies for the two beams are different. As long as Δωτ>2π, the total phase will go through at least one full 2π cycle, where a rectifier or a magnitude-reading PSD will allow one to then obtain a stable and repeatable measure of the interference signal. With a suitable choice of Δω, a heterodyne approach will provide good results irrespective of the magnitude of the Doppler shift.

FIGS. 11 and 12 also illustrate that the heterodyne and homodyne techniques respectively can be integrated with the normal incidence illumination and multi-element detection techniques described above. Such integrations provide the benefits of higher illumination intensity with multi-detector background light noise reduction. Heterodyne/homodyne capability can be made user-selectable by inserting and retracting beam splitters/combiners 120/130 using appropriate precision opto-mechanical mechanisms. A system can be built containing both off-axis and on-axis illumination with heterodyne or homodyne detection.

Signal/Noise Ratios

In order to determine if interferometric detection (homodyne or heterodyne detection) will provide greater sensitivity, the signal/noise ratio for the interferometric detection method can be compared to that of the non-interferometric or direct detection method. In the direct or non-heterodyne detection method, the signal/noise ratio is given by,

$${( \frac{S}{N} )}_{nH} = \frac{{i}_{p}}{{( {i}_{h} )}_{n}} = \frac{{i}_{p}}{{( 2 {qBi}_{h} )}^{\frac{1}{2}}} \qquad ( 8 )$$

where (iₕ)ₙ is the detector current due to the haze shot noise.

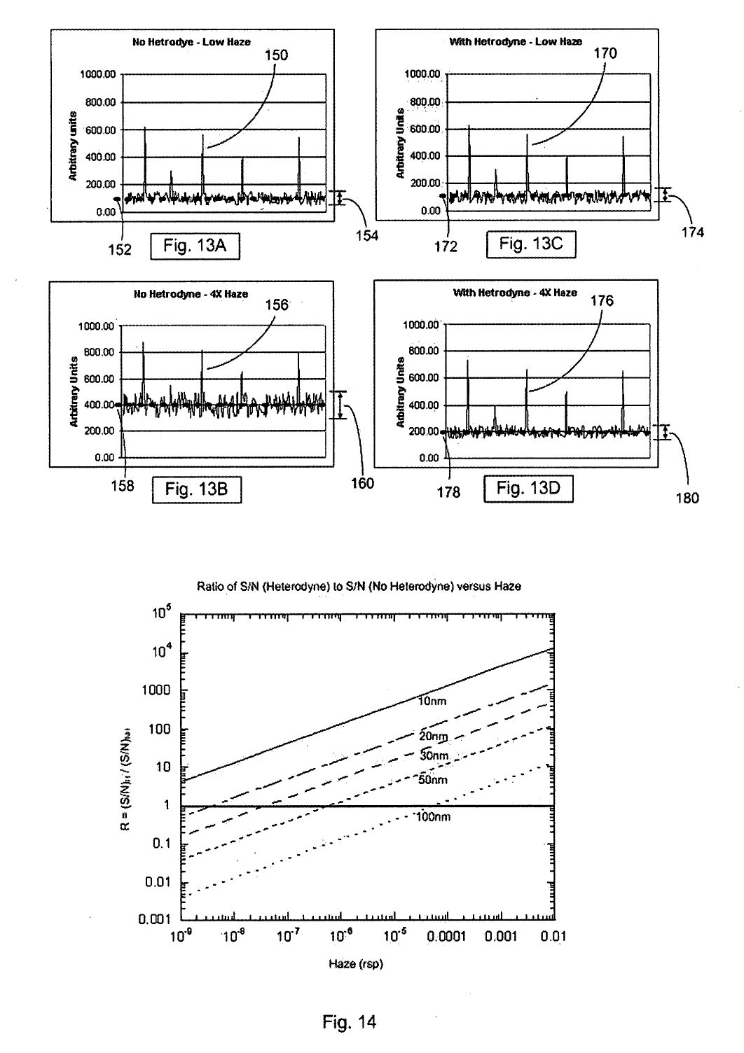

FIGS. 13A and 13B illustrate the detector signals obtained in non-heterodyne detection for two values of haze. In FIG. 13A, the defect signals 150 appear as transient current pulses, i_{p,} from the particles traversing the width of the illuminated stripe. These pulses sit on top of a background 152 given by the haze current, iₕ. The noise on the background 154 arises from the haze shot noise (iₕ)ₙ. In FIG. 13B, the haze is increased by a factor of 4. The pulses 156 from the particles are unchanged. But the background 158 increases by a factor of 4, while the noise on the background 160 increases by a factor of 2. Thus, the increased haze and the resultant increased noise 160 are now making it difficult to detect some of the weaker particle pulses. The signal/noise ratio for particle detection in a non-interferometric detection mode decreases with increased haze.

With interferometric detection, if it is assumed that the reference power is greater than either the scattered power from the particles or from the haze or any other background signal, then the shot noise terms in Eqn. (7) above will be dominated by the reference shot noise. The signal/noise ratio for an interferometric (homodyne or heterodyne) detection will then be given by,

$${( \frac{S}{N} )}_{H} = \frac{2 {( {i}_{p} {i}_{r} )}^{1 / 2}}{{( {i}_{r} )}_{n}} = \frac{2 {( {i}_{p} {i}_{r} )}^{1 / 2}}{{( 2 {qBi}_{r} )}^{1 / 2}} \qquad ( 9 )$$

where (iᵣ)ₙ is the detector current due to the reference beam shot noise.

FIGS. 13C and 13D illustrate the signals that are obtained in a homodyne or heterodyne detection for two values of haze. The transient particle pulses 170 arise from the current 2(iₚiᵣ)^{1/2} which comes from the interference between the transient scattered particle beam and the reference beam. The background 172 arises from the current 2(iₕiᵣ)^{1/2} which comes from the interference between the scattered haze beam and the reference beam. The noise on the background 174 arises from the reference shot noise, (iᵣ)ₙ. The signals in FIG. 13C have been scaled to appear similar to those in FIG. 13A. In FIG. 13D, the haze is increased by a factor of 4. This affects only the background level 178 which now increases by a factor of 2. The particle pulses 176 and the noise on the background 180 remain unchanged and the weaker pulses are still easy to detect. Thus, the great advantage of homodyne or heterodyne detection is that the signal/noise ratio for particle detection becomes independent of the level of haze.

Another issue of interest is a determination of when the signal/noise ratio for interferometric (homodyne or heterodyne) detection is greater than for direct or noninterferometric detection. Eqn. 9 can also be written as,

$${( \frac{S}{N} )}_{H} = \frac{2 {( {i}_{p} {i}_{r} )}^{1 / 2}}{{( 2 {qBi}_{r} )}^{1 / 2}} = \frac{2 {i}_{p}}{{( {i}_{p} )}_{n}} \qquad ( 10 )$$

where (iₚ)ₙ is the detector current due to the scattered particle beam shot noise. Taking the ratio R of the signal/noise for the interferometric (homodyne or heterodyne) detection to the signal/noise for the direct or non-interferometric detection results in:

$$R = \frac{{( \frac{S}{N} )}_{H}}{{( \frac{S}{N} )}_{nH}} = \frac{( \frac{2 {i}_{p}}{{( {i}_{p} )}_{n}} )}{( \frac{{i}_{p}}{{( {i}_{h} )}_{n}} )} = 2 {( \frac{{i}_{h}}{{i}_{p}} )}^{\frac{1}{2}} \qquad ( 11 )$$

When iₕ<¼iₚ, then R<1, while when iₕ>¼iₚ, then R>1. That is, when the haze signal is much smaller than the particle signal, one has better signal/noise with a direct non-interferometric measurement. On the other hand, when the haze signal is greater than the particle signal, it is possible to obtain better signal/noise with an interferometric (homodyne or heterodyne) measurement.

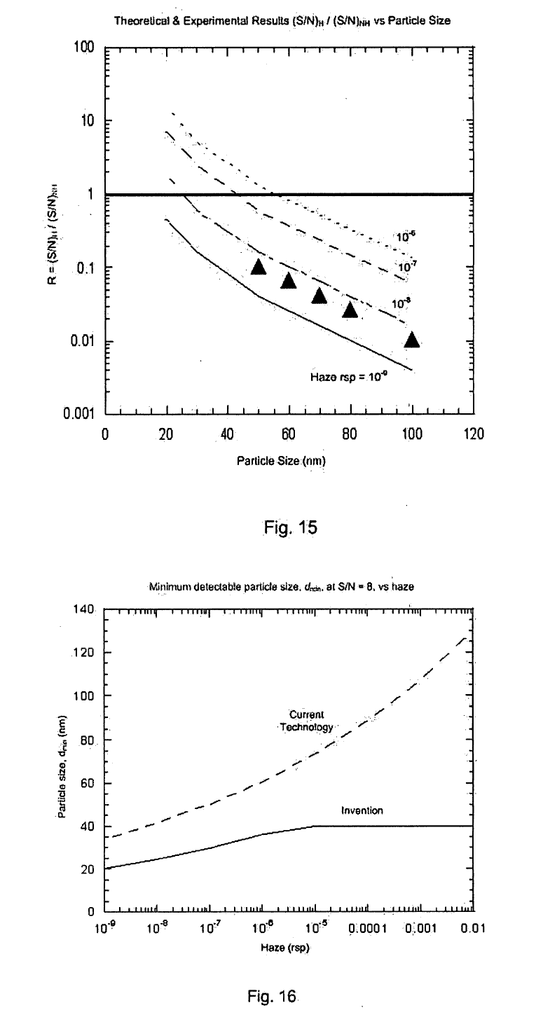

FIG. 14 shows how the comparison ratio R varies with the relative scattering power (rsp) of the haze signal for different particle sizes. Haze rsp is in the 10⁻⁹ to 10⁻⁸ range for prime bare silicon wafers, but increases rapidly for wafers with blanket films or layers, particularly layers of polysilicon or CMP metals. FIG. 15 shows the same analysis but now the comparison ratio R is plotted versus particle size for various values of the haze relative scattering power. The data points shown in FIG. 15 (triangular shapes) are experimental results for the high-sensitivity detection system described above using both non-interferometric and interferometric detection methods. These two graphs clearly show that an interferometric measurement provides a better signal/noise ratio for small particles at moderate to high haze. For larger particles and low values of haze, a direct non-interferometric measurement provides a better signal/noise ratio. In particular, even for particles as small as 30 nm, a non-interferometric measurement is preferred for prime bare silicon wafers where the rsp of the haze is very low (in the 10⁻⁹ to 10⁻⁸ range). However, above moderate haze rsp values of about 10⁻⁷, the interferometric measurement is preferred.

FIG. 16 is a plot of the theoretical minimum detectable particle size at a S/N ratio of 8 for both a Current Technology (i.e. the prior art) and the Invention (i.e. the high-sensitivity techniques described herein). In the Current Technology, the minimum detectable particle size at a S/N of 8 is 35 nm at a haze rsp of 10⁻⁹. As the haze increases, the minimum detectable particle size also increases, reaching 60 nm at moderate haze levels and well over 100 nm at high haze levels. In the high-sensitivity Invention system, the minimum detectable particle size at the lowest haze levels is 20 nm thanks to the 25× improvement in sensitivity using non-interferometric measurements in the high-sensitivity Invention system. As the haze level increases, the minimum detectable particle size increases up to 35-40 nm still using the non-interferometric measurement method. However, this is the haze range where an interferometric measurement has better sensitivity. Thus at this point, one would begin to use a homodyne or heterodyne detection method in the high-sensitivity system. As shown above, the interferometric method makes the S/N ratio insensitive to the level of haze. Thus the minimum detectable particle size stays constant at about 40 nm even for high values of haze. By comparing the two curves in FIG. 16, it is seen that while the increase in sensitivity of the disclosed Invention (high-sensitivity system) compared to the Current Technology system is 25× at low haze values, it is about 200× at moderate haze values and more than 1000× at high haze values.

The high-sensitivity system disclosed herein has two major advantages over conventional systems. First, where the conventional system has marginal performance at the 32 nm technology node, it appears that the high-sensitivity system can meet the industry requirements of 95% defect capture rate and <1 ppm false counts (S/N=8) with a throughput of 60 wph down to at least the 20 nm technology node. Secondly, the high-sensitivity system can detect much smaller defects in the presence of moderate to high haze, a condition usually found on most processed wafers with layers or films.

It is to be understood that the present invention is not limited to the embodiment(s) described above and illustrated herein, but encompasses any and all variations falling within the scope of the appended claims. For example, materials, processes and numerical examples described above are exemplary only, and should not be deemed to limit the claims. Further, it is well known that the function of any optical element usually can be accomplished using a plurality of optical elements, and vice versa. As is apparent from the claims and specification, not all method steps need be performed in the exact order illustrated or claimed, but rather in any order that allows for accurate and efficient inspection of surfaces. While the description above and figures describe and show the homodyne/heterodyne reference beam being generated by picking off a portion of the probe beam (i.e. taking a portion of the probe beam power, taking a particular wavelength of light from the probe beam, etc.), other sources of the reference beam can be used so long as there is general coherence between the two beams. For example, the reference beam could be generated from a separate output of the same light source (e.g. the light source is a laser that produces multiple output beams from the same laser cavity), or a separate light source can be used (e.g. one light source is slaved to the other light source to achieve general coherence). Lastly, while the inspection system and techniques are described with respect to unpatterned wafers, any appropriate surface can be inspected.

What is claimed is:

1. An inspection system for inspecting a sample surface, comprising:
a light source for generating a probe beam of light;
one or more first optical elements for focusing the probe beam onto a sample surface, wherein the sample surface scatters the light forming a scattered probe beam that is captured by the one or more first optical elements;
one or more second optical elements for imaging the scattered probe beam onto a detector, wherein the detector includes a plurality of detector elements that generate output signals in response to the scattered probe beam; and
a processor for analyzing the output signals to identify defects on the sample surface.

2. The system of claim 1, wherein the probe beam is incident on the one or more first optical elements in a direction generally normal to the sample surface.

3. The system of claim 1, wherein the one or more first optical elements is a lens with an NA that is equal to or greater than 0.5.

4. The system of claim 1, further comprising:
one or more third optical elements for shaping the probe beam prior to the probe beam being focused by the one or more first optical elements, such that the probe beam has an elongated stripe shape at the one or more first optical elements and at the sample surface.

5. The system of claim 4, wherein the stripe shape at the one or more first optical elements is of sufficient length to provide an effective focusing NA by the one or more first optical elements of at least 0.5.

6. The system of claim 5, wherein the stripe shape at the surface of the wafer has a length to width aspect ratio of at least 5.

7. The system of claim 4, wherein the stripe shape at the surface of the wafer has a total area less than 500 μm².

8. The system of claim 4 further comprising:
a stage for rotating the sample surface in a spin direction, wherein the elongated stripe shape of the probe beam at the sample surface has a length dimension oriented perpendicular to the spin direction, and wherein the stage translates the sample in a direction parallel to the length dimension.

9. The system of claim 3, wherein the probe beam passes through a portion of the focusing lens that is offset from a center of the lens.

10. The system of claim 1, wherein the probe beam passes through a portion of the one or more first optical elements that is offset from a center of the one or more first optical elements.

11. The system of claim 1, further comprising:
a first polarizer element disposed in the probe beam; and
a second polarizer element disposed in the scattered probe beam, wherein the first and second polarizer elements have polarizer axes oriented generally orthogonally to each other.

12. The system of claim 11, wherein the first polarizer element is a linear polarizer element oriented to pass p-polarized light, and wherein the second polarizer element is a linear polarizer element oriented to pass s-polarized light.

13. The system of claim 4, wherein the detector elements are oriented in a one-dimensional linear array, and wherein the one or more second optical elements image the scattered probe beam onto the detector such that there is a one-to-one correspondence between locations along the stripe shape of the probe beam at the wafer surface and the detector elements of the detector.

14. The system of claim 4, wherein the detector elements are oriented in a two-dimensional array, and wherein the one or more second optical elements image the scattered probe beam onto the detector such that there is a one-to-one correspondence between locations along the stripe shape of the probe beam at the wafer surface and the detector elements of the detector.

15. The system of claim 1, further comprising:
one or more third optical elements for directing a reference beam to the detector.

16. The system of claim 15, wherein the one or more third optical elements generate the reference beam from the probe beam.

17. The system of claim 15, wherein the one or more third optical elements receive the reference beam from a second light source, and wherein there is general coherence between the probe beam and the reference beam.

18. The system of claim 15, further comprising:
an electronic circuit for obtaining a magnitude of a homodyne signal formed from an optical interference between the scattered probe beam and the reference beam at the detector.

19. The system of claim 15, further comprising:
at least one optical element for altering an optical frequency of at least one of the reference beam, the probe beam and the scattered probe beam.

20. The system of claim 19, further comprising:
an electronic circuit for obtaining a magnitude of a heterodyne signal formed from an optical interference between the scattered probe beam and the reference beam at the detector.

21. An inspection system for inspecting a sample surface, comprising:
a light source for generating a probe beam of light;
one or more first optical elements for focusing the probe beam onto a sample surface via normal incidence illumination, wherein the sample surface scatters the light forming a scattered probe beam that is captured by the one or more first optical elements, and wherein the one or more first optical elements has an effective focusing NA for the probe beam of at least 0.5;
one or more second optical elements for directing the scattered probe beam onto a detector that generates output signals in response to the scattered probe beam; and
a processor for analyzing the output signals to identify defects on the sample surface.

22. The system of claim 21, wherein:
the one or more second optical elements image the scattered probe beam onto the detector; and
the detector includes a plurality of detector elements that generate the output signals.

23. The system of claim 21, further comprising:
one or more third optical elements for shaping the probe beam prior to the probe beam being focused by the one or more first optical elements, such that the probe beam has an elongated stripe shape at the one or more first optical elements and at the sample surface.

24. The system of claim 23, wherein the stripe shape at the surface of the wafer has a length to width aspect ratio of at least 5.

25. The system of claim 23, wherein the stripe shape at the surface of the wafer has a total area less than 500 μm².

26. The system of claim 23, further comprising:
a stage for rotating the sample surface in a spin direction, wherein the elongated stripe shape of the probe beam at the sample surface has a length dimension oriented perpendicular to the spin direction, and, wherein the stage translates the sample in a direction parallel to the length dimension.

27. The system of claim 21, wherein the probe beam passes through a portion of the one or more first optical elements that is offset from a center of the one or more first optical elements.

28. The system of claim 21, further comprising:
a first polarizer element disposed in the probe beam; and
a second polarizer element disposed in the scattered probe beam, wherein the first and second polarizer elements have polarizer axes oriented generally orthogonally to each other.

29. The system of claim 28, wherein the first polarizer element is a linear polarizer element oriented to pass p-polarized light, and wherein the second polarizer element is a linear polarizer element oriented to pass s-polarized light.

30. The system of claim 22, wherein the detector elements are oriented in a one-dimensional linear array, and wherein the one or more second optical elements image the scattered probe beam onto the detector such that there is a one-to-one correspondence between locations of the probe beam at the wafer surface and the detector elements of the detector.

31. The system of claim 22, wherein the detector elements are oriented in a two-dimensional array, and wherein the one or more second optical elements image the scattered probe beam onto the detector such that there is a one-to-one correspondence between locations of the probe beam at the wafer surface and the detector elements of the detector.

32. An inspection system for inspecting a sample surface, comprising:
a light source for generating a probe beam of light;
one or more first optical elements for focusing the probe beam onto a sample surface via normal incidence illumination, wherein the sample surface scatters the light forming a scattered probe beam that is captured by the one or more first optical elements;
one or more second optical elements for directing the scattered probe beam onto a detector;
one or more third optical elements for directing a reference beam to the detector, wherein the detector generates output signals in response to the scattered probe beam and the reference beam; and
a processor for analyzing the output signals to identify defects on the sample surface.

33. The system of claim 32, wherein the one or more third optical elements generate the reference beam from the probe beam.

34. The system of claim 32, wherein the one or more third optical elements receive the reference beam from a second light source, and wherein there is general coherence between the probe beam and the reference beam.

35. The system of claim 32, further comprising:
an electronic circuit for obtaining a magnitude of an interferometric signal formed from an optical interference between the scattered probe beam and the reference beam at the detector, wherein the processor analyzes the interferometric signal for identifying the defects on the sample surface.

36. The system of claim 35, further comprising:
at least one optical element for altering an optical frequency of at least one of the reference beam, the probe beam and the scattered probe beam.

37. The system of claim 32, wherein:
the one or more second optical elements image the scattered probe beam onto the detector; and
the detector includes a plurality of detector elements that generate the output signals.

38. The system of claim 32, further comprising:
one or more fourth optical elements for shaping the probe beam prior to the probe beam being focused by the one or more first optical elements, such that the probe beam has an elongated stripe shape at the one or more first optical elements and at the sample surface.

39. The system of claim 38, wherein the stripe shape at the one or more first optical elements is of sufficient length to provide an effective focusing NA by the one or more first optical elements of at least 0.5.

40. The system of claim 38, wherein the stripe shape at the surface of the wafer has a length to width aspect ratio of at least 5.

41. The system of claim 38, wherein the stripe shape at the surface of the wafer has a total area less than 500 μm².

42. The system of claim 38 further comprising:
a stage for rotating the sample surface in a spin direction, wherein the elongated stripe shape of the probe beam at the sample surface has a length dimension oriented perpendicular to the spin direction, and wherein the stage translates the sample in a direction parallel to the length dimension.

43. The system of claim 32, wherein the probe beam passes through a portion of the one or more first optical elements that is offset from a center of the one or more first optical elements.

44. The system of claim 32, further comprising:
a first polarizer element disposed in the probe beam; and
a second polarizer element disposed in the scattered probe beam, wherein the first and second polarizer elements have polarizer axes oriented generally orthogonally to each other.

45. The system of claim 44, wherein the first polarizer element is a linear polarizer element oriented to pass p-polarized light, and wherein the second polarizer element is a linear polarizer element oriented to pass s-polarized light.

46. The system of claim 37, wherein the detector elements are oriented in a one-dimensional linear array, and wherein the one or more second optical elements image the scattered probe beam onto the detector such that there is a one-to-one correspondence between locations of the probe beam at the wafer surface and the detector elements of the detector.

47. The system of claim 37, wherein the detector elements are oriented in a two-dimensional array, and wherein the one or more second optical elements image the scattered probe beam onto the detector such that there is a one-to-one correspondence between locations of the probe beam at the wafer surface and the detector elements of the detector.

48. A method of inspecting a sample surface, comprising:
generating a probe beam of light;
focusing the probe beam onto a sample surface using one or more first optical elements, wherein the sample surface scatters the light forming a scattered probe beam;
capturing the scattered probe beam with the one or more first optical elements;
imaging the scattered probe beam onto a detector, wherein the detector includes a plurality of detector elements that generate output signals in response to the scattered probe beam; and
analyzing the output signals to identify defects on the sample surface.

49. The method of claim 48, wherein the probe beam is incident on the one or more first optical elements in a direction generally normal to the sample surface.

50. The method of claim 48, further comprising:
shaping the probe beam prior to the probe beam being focused by the one or more first optical elements, such that the probe beam has an elongated stripe shape at the one or more first optical elements and at the sample surface.

51. The method of claim 50, wherein the stripe shape at the surface of the wafer has a length to width aspect ratio of at least 5.

52. The method of claim 50, wherein the stripe shape at the one or more first optical elements is of sufficient length to provide an effective focusing NA by the one or more first optical elements of at least 0.5.

53. The method of claim 50, further comprising:
rotating the sample surface in a spin direction, wherein the elongated stripe shape of the probe beam at the sample surface has a length dimension oriented perpendicular to the spin direction; and
translating the sample in a direction parallel to the length dimension.

54. The method of claim 48, wherein the probe beam passes through a portion of the one or more first optical elements that is offset from a center of the one or more first optical elements.

55. The method of claim 48, further comprising:
passing the probe beam through a first polarizer element; and
passing the scattered probe beam through a second polarizer element, wherein the first and second polarizer elements have polarizer axes oriented generally orthogonally to each other.

56. The method of claim 55, wherein the first polarizer element is a linear polarizer element oriented to pass p-polarized light, and wherein the second polarizer element is a linear polarizer element oriented to pass s-polarized light.

57. The method of claim 50, wherein the detector elements are oriented in a one-dimensional or a two-dimensional array, and wherein the one or more second optical elements image the scattered probe beam onto the detector such that there is a one-to-one correspondence between locations along the stripe shape of the probe beam at the wafer surface and the detector elements of the detector.

58. The method of claim 50, further comprising:
directing a reference beam that is generally coherent with the probe beam to the detector.

59. The method of claim 58, further comprising:
obtaining a magnitude of a homodyne signal formed from an optical interference between the scattered probe beam and the reference beam at the detector.

60. The method of claim 58, further comprising:
altering an optical frequency of at least one of the reference beam, the probe beam and the scattered probe beam.

61. The method of claim 60, further comprising:
obtaining a magnitude of a heterodyne signal formed from an optical interference between the scattered probe beam and the reference beam at the detector.

62. A method of inspecting a sample surface, comprising:
generating a probe beam of light;
focusing the probe beam onto a sample surface via normal incidence illumination using one or more first optical elements, wherein the sample surface scatters the light forming a scattered probe beam, and wherein the one or more first optical elements has an effective focusing NA for the probe beam of at least 0.5;
capturing the scattered probe beam with the one or more first optical elements;
directing the scattered probe beam onto a detector, wherein the detector generates output signals in response to the scattered probe beam; and
analyzing the output signals to identify defects on the sample surface.

63. The method of claim 62, wherein:
the directing comprises imaging the scattered probe beam onto the detector; and
the detector includes a plurality of detector elements that generate the output signals.

64. The method of claim 62, further comprising:
shaping the probe beam prior to the probe beam being focused by the one or more first optical elements, such that the probe beam has an elongated stripe shape at the one or more first optical elements and at the sample surface.

65. The method of claim 64, wherein the stripe shape at the surface of the wafer has a length to width aspect ratio of at least 5.

66. The method of claim 64, further comprising:
rotating the sample surface in a spin direction, wherein the elongated stripe shape of the probe beam at the sample surface has a length dimension oriented perpendicular to the spin direction; and
translating the sample in a direction parallel to the length dimension.

67. The method of claim 62, wherein the probe beam passes through a portion of the one or more first optical elements that is offset from a center of the one or more first optical elements.

68. The method of claim 62, further comprising:
passing the probe beam through a first polarizer element; and
passing the scattered probe beam through a second polarizer element, wherein the first and second polarizer elements have polarizer axes oriented generally orthogonally to each other.

69. The method of claim 68, wherein the first polarizer element is a linear polarizer element oriented to pass p-polarized light, and wherein the second polarizer element is a linear polarizer element oriented to pass s-polarized light.

70. The method of claim 63, wherein the detector elements are oriented in a one dimensional or a two dimensional linear array configuration, and wherein the one or more second optical elements image the scattered probe beam onto the detector such that there is a one-to-one correspondence between locations of the probe beam at the wafer surface and the detector elements of the detector.

71. A method of inspecting a sample surface, comprising:
generating a probe beam of light;
focusing the probe beam onto a sample surface via normal incidence illumination using one or more first optical elements, wherein the sample surface scatters the light forming a scattered probe beam;
capturing the scattered probe beam with the one or more first optical elements;
directing the scattered probe beam onto a detector;
generating a reference beam;
directing the reference beam to the detector, wherein the detector generates output signals in response to the scattered probe beam and the reference beam; and
analyzing the output signals to identify defects on the sample surface.

72. The method of claim 71, wherein the generating a reference beam comprises:
generating the reference beam from the probe beam.

73. The method of claim 71, wherein there is a general coherence between the probe beam and the reference beam.

74. The method of claim 71, further comprising:
obtaining a magnitude of an interferometric signal formed from an optical interference between the scattered probe beam and the reference beam at the detector, wherein the analyzing of the output signals includes analyzing the interferometric signal.

75. The method of claim 71, further comprising:
altering an optical frequency of at least one of the reference beam, the probe beam and the scattered probe beam.

76. The method of claim 71, wherein:
the directing of the reference beam to the detector further comprises imaging the scattered probe beam onto the detector; and
the detector includes a plurality of detector elements for generating the output signals.

77. The method of claim 71, further comprising:
shaping the probe beam prior to the probe beam being focused by the one or more first optical elements, such that the probe beam has an elongated stripe shape at the one or more first optical elements and at the sample surface.

78. The method of claim 77, wherein the stripe shape at the one or more first optical elements is of sufficient length to provide an effective focusing NA by the one or more first optical elements of at least 0.5.

79. The method of claim 77, wherein the stripe shape at the surface of the wafer has a length to width aspect ratio of at least 5.

80. The method of claim 77, further comprising:
rotating the sample surface in a spin direction, wherein the elongated stripe shape of the probe beam at the sample surface has a length dimension oriented perpendicular to the spin direction; and
translating the sample in a direction parallel to the length dimension.

81. The method of claim 71, wherein the probe beam passes through a portion of the one or more first optical elements that is offset from a center of the one or more first optical elements.

82. The method of claim 71, further comprising:
passing the probe beam through a first polarizer element; and
passing the scattered probe beam through a second polarizer element, wherein the first and second polarizer elements have polarizer axes oriented generally orthogonally to each other.

83. The method of claim 76, wherein the detector elements are oriented in a one-dimensional or a two dimensional array, and wherein the one or more second optical elements image the scattered probe beam onto the detector such that there is a one-to-one correspondence between locations of the probe beam at the wafer surface and the detector elements of the detector.
